(19) United States
(12) Patent Application Publication
(10) Pub. No.: US 2014/0027990 A1
(43) Pub. Date: Jan. 30, 2014

(54) MECHANIC'S CREEPER HAVING INTEGRATED LIGHTS POWERED BY A RECHARGEABLE BATTERY

(71) Applicant: BENITO TRIGLIA, Poughkeepsie, NY (US)

(72) Inventor: BENITO TRIGLIA, Poughkeepsie, NY (US)

(21) Appl. No.: 13/951,657

(22) Filed: Jul. 26, 2013

Related U.S. Application Data
(60) Provisional application No. 61/675,866, filed on Jul. 26, 2012.

(51) Int. Cl. F21V 33/00; B62B 3/00

(52) U.S. Cl. CPC F21V 33/0084; B62B 3/00
USPC 280/32.6; 362/183; 362/190

(57) ABSTRACT

An improved mechanic's creeper includes an integrated light bar having a plurality of lights that are powered by a rechargeable battery. A conventional rechargeable battery, for example a 19.2 volt battery, is charged in a charging cradle then engaged with the creeper for use. The mechanic uses the creeper in the ordinary manner, except may flip a switch for light as desired. The light bar pivots, thereby allowing the mechanic to illuminate underneath a car while working. After use the battery may be returned to the charging cradle for subsequent use. In an alternative embodiment the creeper is powered by a solar panel.

### CROSS-REFERENCE TO RELATED APPLICATIONS

This application claims priority from U.S. Provisional Patent Application 61/675,866, filed Jul. 26, 2012.

### BACKGROUND OF THE INVENTION

The present invention relates to devices used in automotive servicing, and more particularly, to a mechanic's creeper having integrated lights powered by a rechargeable battery.

In performing automotive repairs and maintenance it is often necessary to work on the underside of the vehicle. Given the limited amount of space and difficulty in accessing this area, mechanics often use “creepers” to roll to the desired location. Mechanic's creepers are typically low profile platforms on wheels, and sometimes include accessories such as padding.

Unfortunately, however, once the mechanic has accessed the desired area, they still face the issue of inadequate light. This is typically overcome by using a flashlight or electrically powered light. Both of these are problematic for a variety of reasons including: lights must be secured in order to shine on the desired work area and this is inconvenient and heightens the profile; batteries die; electrical cords get in the way; lights generate a lot of heat; and/or are bulky.

As can be seen, there is a need for a mechanic's creeper that includes fixed lights that illuminate the mechanic's work area. It is desirable that the vertical profile of this creeper remains low. It is desirable that the light source of this creeper is cordless, and doesn't generate a lot of heat. It is also desirable that this creeper is approximately the same width as conventional creepers. It is also desirable that this creeper is easy to use and comfortable.

### SUMMARY OF THE INVENTION

An improved mechanic's creeper includes a body portion having a platform on which a mechanic lays, plus an extension portion that includes a pivotable light bar. The light bar includes a plurality of light bulbs, preferably about three. Lights in the light bar are powered by a rechargeable battery which is engaged with the creeper for use, then disengaged for charging using a separate charging cradle. In this manner the improved mechanic's creeper is able to illuminate the underside of a vehicle, but doesn't have power cords that can be cumbersome or dangerous. Moreover, the light bar doesn't increase the profile of the creeper, so it can still fit under vehicles as a conventional creeper would.

In an alternative embodiment the creeper includes a solar panel for powering the lights.

### BRIEF DESCRIPTION OF THE DRAWINGS

FIG. 1 is a top view of an embodiment of the invention;

FIG. 2 is a top view of another embodiment of the invention;

FIG. 3 is an end view of an embodiment of the invention, taken at the head end;

FIG. 4 is a perspective view of some structures of the extension portion of the present invention;

FIG. 5 is a top view of some structures of the extension portion of the present invention; and

FIG. 6 is a bottom view of some features of the extension portion of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

As used herein, the following numbers shall apply to the following structures among the various FIGS.:

10—Creeper;

17—Frame;

18—Wiring channel;

20—Body;

22—Platform;

24—Caster;

26—Wheel;

28—Switch;

29—Battery;

30—Extension;

32—Light bar;

34—Pivot hinge;

36—Light bulb;

38—Solar panel;

40—Negative wire;

41—Positive wire;

43—Stud;

45—Bulb hole;

46—Ground; and

48—Tension plate.

Broadly, an embodiment of the present invention provides a mechanic's creeper having an extension at the head-end, with the extension including a battery operated light assembly. The associated battery, battery holder, wiring and switch are also integrated into the creeper. In an alternative embodiment, the light is solar powered.

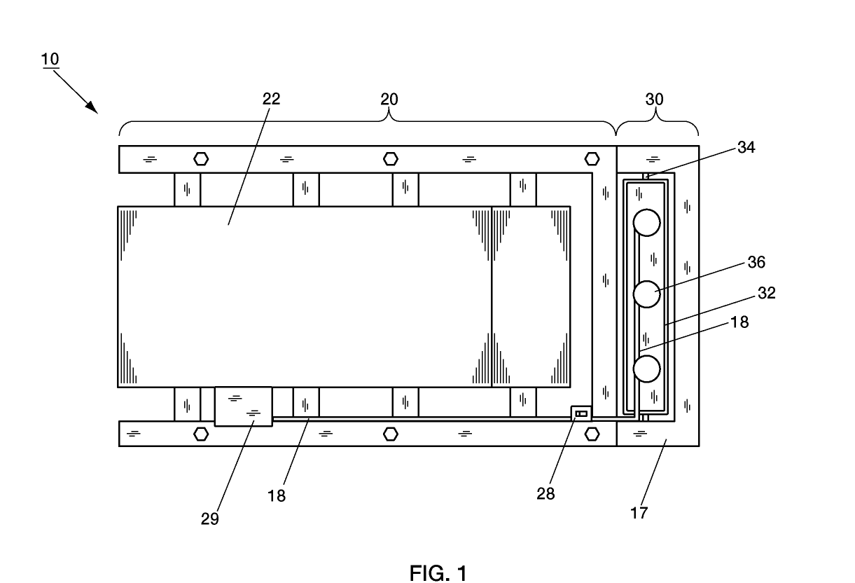

Referring to FIG. 1, creeper 10 generally includes body 20, and extension 30, surrounded by frame 17. Crossbar of frame (not numbered) separates body portion from extension portion. Body 20 includes platform 22, upon which a user of the device would lay, with the head end near extension 30, and foot end opposite. Extension 30 includes light bar 32 having a plurality of light bulbs 36, desirably one to five lights, but preferably three. Light bar 32 is pivotable at pivot hinge 34. In this manner a user can direct light as desired. The type of bulb could vary, with an 18V 6 A bulb being particularly suitable.

Wiring (not shown) within wiring channel 18 electrically connects light bulbs 36 to battery 29. Battery 29 is desirably a 19.2 volt battery, such as that which is found in standard cordless drills. An example of such a cordless drill is the Craftsman 315116890 19.2V DC Cordless Drill. While it is desirable that wiring is within wiring channel 19 for safely and aesthetics, this structure may be omitted. Switch 28 allows mechanic to turn light bulbs 36 on and off as desired.

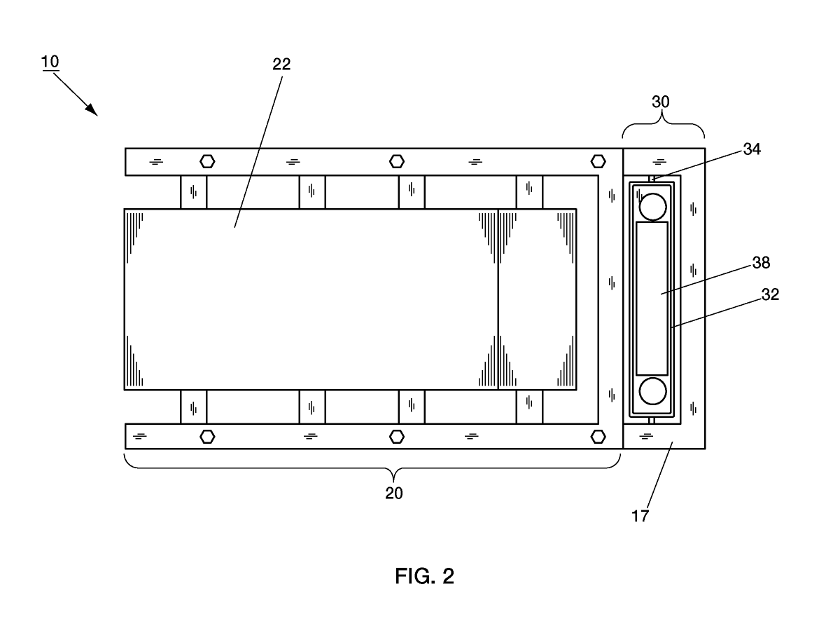

FIG. 2 shows an embodiment having two light bulbs 36, which are powered by solar panel 38. In this embodiment solar energy collected by solar panel 38 is stored within a battery (not shown), and used to power light bulbs 36 in use. The configuration and number of bulbs could vary in this alternative embodiment.

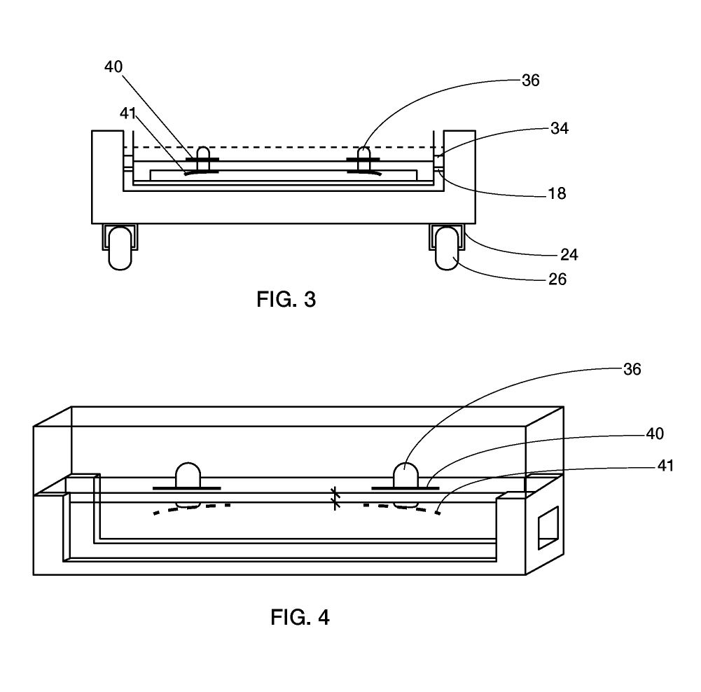

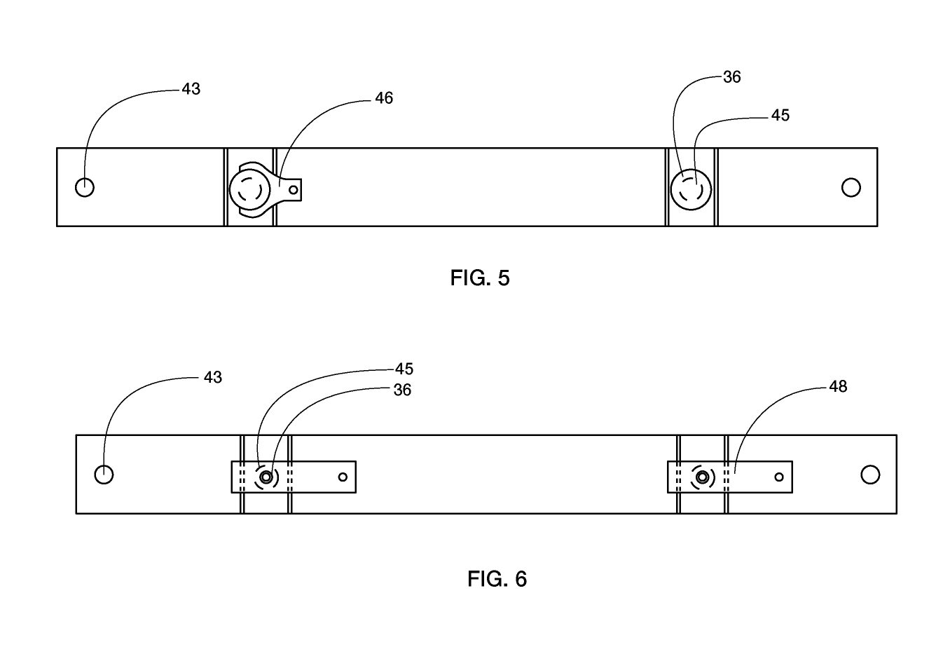

As shown in FIG. 3, which generally depicts a cross sectional view of an embodiment, wheels 26 are held in position by casters 24. FIGS. 4-6 depict the orientation of various electrical connections and components, although it should be understood that the particular orientation could vary.

In use, one would charge rechargeable battery 29 in standard manner, for example in the charging cradle that is plugged into a standard 110V outlet. Once charged, battery 29 is engaged with creeper. The mechanic or other user lays on their back on creeper 10 and rolls under the vehicle in the ordinary manner. Once they are in the desired location, switch 28 is flipped and light bulbs 36 illuminate. Light bar 32 can be tilted as desired to get light in exact position. Work on the underside of the vehicle is performed as usual. Upon completion, lights are turned off at switch 28, mechanic rolls out from under the vehicle, removes battery 29, and recharges battery 29 in charging cradle (not shown).

It should be understood, of course, that the foregoing relates to exemplary embodiments of the invention and that modifications may be made without departing from the spirit and scope of the invention as set forth in the following claims. It should also be understood that ranges of values set forth inherently include those values, as well as all increments between.

What is claimed is:

1. A mechanic's creeper including;
a. A rectangular platform having a head end and a foot end;
b. An extension adjacent said head end, said extension including a pivotable light bar; and
c. A rechargeable battery electrically coupled to said light bar.

2. The mechanic's creeper of claim 1 wherein said light bar is pivotable along an axis perpendicular to the longitudinal axis of said platform.

3. The mechanic's creeper of claim 1 wherein said light bar includes a plurality of light bulbs.

4. The mechanic's creeper of claim 3 wherein at least one of said light bulbs is a 18V 6 A bulb.

5. The mechanic's creeper of claim 4 wherein said rechargeable battery is a 19.2 volt rechargeable battery.

6. The mechanic's creeper of claim 5 wherein said rechargeable battery is disengageable.

7. A cordless light-emitting mechanic's creeper including:
a. A rigid frame defining a body portion and an extension portion, said portions separated by a crossbar of said frame;
b. A platform engaged with the frame of said body portion;
c. A light bar engaged with the frame of said extension portion; and
d. A power source engaged with said frame.

8. The mechanic's creeper of claim 7 wherein said power source includes a solar panel engaged with said extension portion.

9. The mechanic's creeper of claim 7 further including a plurality of wheels engaged with said frame.

10. The mechanic's creeper of claim 7 wherein said light bar is engaged with the frame of said extension portion by a pair of opposing pivot hinges.

11. The mechanic's creeper of claim 10 wherein said power source is removeable from said frame.

12. The mechanic's creeper of claim 11 wherein said power source is a 19.2 volt battery.

13. The mechanic's creeper of claim 12 further including a switch in electrical communication with said light bar and said power source.

14. A method of illuminating the underside of a vehicle including the steps of:
a. Charging a 19.2 V battery on a charging cradle using a 110 V outlet;
b. Disengaging said battery from said charging cradle;
c. Engaging said battery with a mechanic's creeper;
d. Rolling said mechanic's creeper under a vehicle;
e. Flipping a switch to power light bulbs on a light bar; and
f. Pivoting said light bar to illuminate desired area.

15. The method of claim 14 further comprising the step of disengaging said battery from said mechanic's creeper.

16. The method of claim 15 further comprising the step or recharging said 19.2 V battery on a charging cradle.

17. The method of claim 14 further comprising the step of laying on said mechanic's creeper.
